(19) United States
(12) Patent Application Publication
(10) Pub. No.: US 2009/0033106 A1
(43) Pub. Date: Feb. 5, 2009

(54) LATCHING BRACKET

(75) Inventor: Gary A. West, Mississauga (CA)

Correspondence Address: DARYL W SCHNURR;MILLER THOMSON LLP, ACCELERATOR BUILDING, 295 HAGEY BLVD., SUITE 300, WATERLOO, ON, N2L 6R5, CA

(73) Assignee: ACCESS RETAIL GROUP INC.

(21) Appl. No.: 11/831,655

(22) Filed: Jul. 31, 2007

(51) Int. Cl. E05C 17/36

(52) U.S. Cl. 292/264

(57) ABSTRACT

A latching bracket is used on a truck box and the like for holding a door or other hinged object in an open position. The latching bracket has a post extending upward from a base. The post is enclosed in a housing having an opening at a front thereof to allow a loop on a rope to be installed over the post by inserting the loop through the openings. The bracket is mounted on a supporting surface. A latching bracket and rope in combination is also described.

### BACKGROUND OF THE INVENTION

1. Field of the Invention

This invention relates to a latching bracket for use on a truck box and the like to receive a loop on a flexible elongated member and to a latching bracket and flexible elongated member in combination.

2. Description of the Prior Art

Truck boxes and truck trailers often have hinged doors at various positions therein and particularly at a rear of the truck box or trailer. The doors are usually hinged along outer edges and have locking handles or rods attached thereto, which are conventional. When the rear doors are open, it is sometimes desirable to have a retaining device mounted on either side of the truck body or trailer to hold the doors in an open position. The rear doors are hinged at the outer rear corner of the truck box.

It is known to mount retaining brackets in an outside side wall of the truck box. A chain is affixed to each door so that the doors can be opened approximately 270 degrees and are held adjacent to the outside of each side wall on either side of the truck box by a link of each chain that is inserted into the adjacent retaining bracket.

A door or gate retainer is described in Lahey U.S. Pat. No. 6,478,348 issued Nov. 12, 2002. A latch for retaining doors and the like in an open position is described in Tucket et al U.S. Pat. No. 4,422,678 issued Dec. 27, 1983 and another fastening means for gates and other objects is described in Ahearn UK Patent Application No. 1155157. When these devices are used on truck boxes they are often used to retain doors in an open position while the truck is moved or driven short distances under off road conditions at a home base or at a loading or unloading location. With the movement of the trucks, there is a certain amount of vibration and it is important that the chains do not slip out of the retainers and that the doors of the truck box be retained in the open position. If the chain separates from the retaining bracket, the doors may close partially and become damaged as the truck continues to move. One of the difficulties encountered with previous devices is that truck drivers will sometimes improperly use the retaining devices or take short cuts in that use in order to save time. For example, with the device described in the Lahey patent, some truck drivers will simply install the link of the chain over the upstanding finger without taking the time to first pass the chain through the bail 6. As the door that is being retained moves back and forth with the movement of the truck, if the retaining device is not used properly, the chain will slip off the upstanding finger and the door will then be released. If the truck passes too closely to another truck in the home base yard for example, the door can become irreparably damaged and will have to be replaced. Similarly, the latch described in the Tucket patent and the fastening means described in the Ahearn application can be misused by hanging the chain over the side of the post without passing the chain through the loop. It can be very expensive for truck owners when doors become damaged through improper use of the retaining devices and the total damages on an annual basis can be quite large for fleet owners.

### SUMMARY OF THE INVENTION

It is an object of the present invention to provide an improved latching bracket for use on an outside wall of a truck box where the latching bracket can only be used in the proper manner.

It is a further object of the present invention to provide a latching bracket and latching bracket and flexible elongated member in combination where the loop of the flexible elongated member cannot be retained in any way by the latching bracket except by inserting the loop through the front opening and over top of the post.

It is a further object of the present invention to provide a latching bracket that cannot be by-passed by persons who are careless or who have not received instruction in proper use of the latching bracket.

A latching bracket is used on an outside of the wall of a truck box to receive a loop of a flexibly elongated member. The bracket comprises a post mounted in a base and extending upward to a free end, the post being surrounded by a housing. The housing has an opening therein, the opening extending from the base to slightly beneath the free end. The opening is sized and shaped to allow a user to insert the loop through the opening and over the free end of the post, thereby removably affixing the elongated member to the bracket.

A latching bracket is used on a supporting surface to receive a loop on a flexible elongated member, the bracket being mounted on the supporting surface. The bracket comprises a post mounted in a base and being surrounded by a frame, a top, two sides and the base, the frame having an opening therein. The post extends upward from the base to a free end that is separate and apart from the frame by a sufficient gap to enable the loop to be inserted into the frame and over the free end. The free end is behind part of the frame, a rear of the bracket being closed off by the supporting surface.

A latching bracket is used on an outside wall of a truck box to receive a loop located on a flexible elongated member. The bracket comprises a post extending upward from a base to a free end. The post is encased in a frame, two sides, a top and the base, the frame having an opening in the front thereof. The opening extends from the base to slightly beneath the free end, there being a cap between the free end and the frame. The opening is sized and shaped to allow a user to insert the loop through the opening and over the free end of the post, the bracket having attachment means for mounting the bracket on the wall.

A latching bracket and flexible elongated member in combination, the latching bracket being used on a wall of a truck box and the flexible elongated member having a loop therein, the bracket comprises a post extending upward from a base. The post has a free end and the post is surrounded by a frame. The frame has an opening located therein, the opening extending from substantially the base to slightly beneath the free end. The opening is sized and shaped to allow a user to insert a loop through the opening and over the free end of the post, thereby removably affixing the elongated member to the bracket.

### BRIEF DESCRIPTION OF THE DRAWINGS

FIG. 1 is a perspective view of a latching bracket mounted on a wall;

FIG. 2 is a perspective view of the latching bracket on a wall when viewed from a side with a chain installed in the bracket;

FIG. 3 is a perspective view of the bracket and chain as shown in FIG. 2 with the bracket being partially cutaway to reveal an interior;

FIG. 4 is a perspective view of the latching bracket on a wall with the chain partially inserted into the bracket;

FIG. 5 is a perspective view of the latching bracket with the chain in the position shown in FIG. 4 and the latching bracket partially cutaway to reveal an interior;

FIG. 6 is a front view of the latching bracket and chain;

FIG. 7 is a side view of the latching bracket and chain with the post shown in dotted lines; and

FIG. 8 is a top view of the latching bracket and chain with the post and part of the chain shown in dotted lines.

### DETAILED DESCRIPTION OF A PREFERRED EMBODIMENT

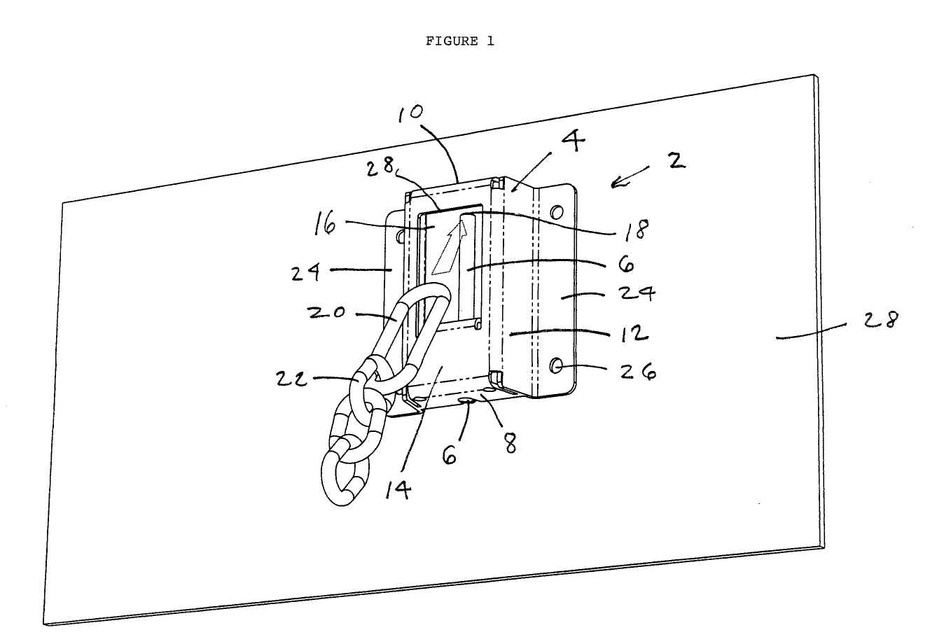

In FIG. 1, a latching bracket 2 has a housing 4 containing a post 6 extending upward from a base 8. The housing 4 has the base 8, a top 10, two sides 12 with a frame 14 at a front thereof. The frame 14 has an opening 16 therein. The post has a free end 18 that extends slightly above an upper edge of the opening 16. There is a gap between the frame and the free end 18 that is sufficient to allow a loop 20 of a chain 22 to be inserted through the opening 16, over the free end 18 and onto the post 6. The latching bracket 2 has two flanges 24 extending out either side 13 of the latching bracket 2 with holes 26 therein to receive screws or bolts (not shown) to attach the latching bracket 2 to a supporting surface 28.

The loop 20 is elongated compared to other lengths in the chain 22 to make it easier to install the loop over the post 6. While the loop 20 is shown as being part of a chain, any flexible elongated member can be used with a loop including, without limiting the generality of the foregoing, a rope, wire, string, belt or strap. The loop can be made from the same material as the flexible elongated member or the loop can be made from different material. For example a metal loop can be used with a plastic rope.

The chain 22 has an end (not shown) opposite to the loop 20 that is connected to whatever object, for example, an inside of a door that a user wishes to retain. The bracket being mounted on the wall is the preferred arrangement, particularly when used on a truck box, but, alternatively, the bracket can be mounted on the door and the chain can be affixed to the wall for connection to the bracket to retain the door in the open position. While the loop 20 is preferably located at the end of the chain that is removably installed in the bracket 2, the loop can be located at an intermediate point on the elongated member or there can be more than one loop located on the elongated member in those circumstances where it is desirable to vary the length of the elongated member between the fixed end and the loop. As a further variation, the chain 22 can be made up entirely of links that are elongated in the same manner as the loop 20. The arrow in FIG. 1 shows the direction in which the loop must be moved upward and inward in order to install the loop over the post. The gap between a lower edge 28 of the upper part of the frame is sufficiently large that the loop 20 can fit between the lower edge of the frame and the free end of the post. The loop is removed from the post in the opposite manner.

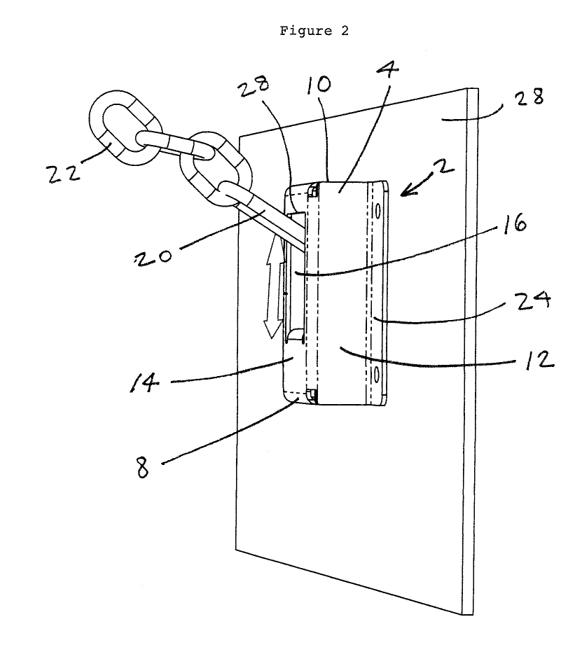

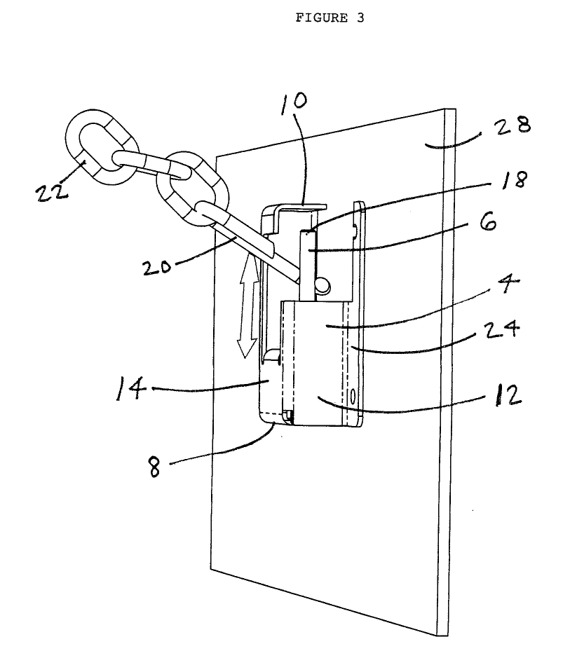

In FIGS. 2-8, the same reference numerals are used in as those used in FIG. 1 for those components that are identical. In FIGS. 2 and 3, the loop 20 is installed on the post 6 and is partway down the opening 16. The double arrow in FIGS. 2 and 3 indicates that the chain 22 and loop 20 can move upward or downward within the opening 16. From FIG. 3, it can be seen that the free end 18 of the post extends slightly above the lower edge 28. Part of the housing 4 has been cutaway in FIG. 3 to expose the loop 20 on the post 6. Also, part of the loop 20 has been cutaway to clearly show the loop being installed on the post.

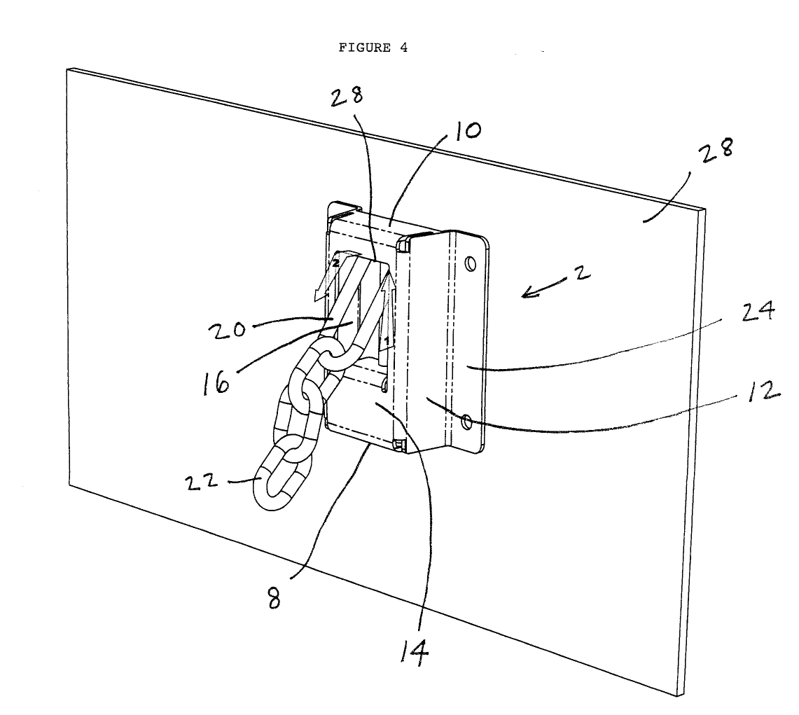

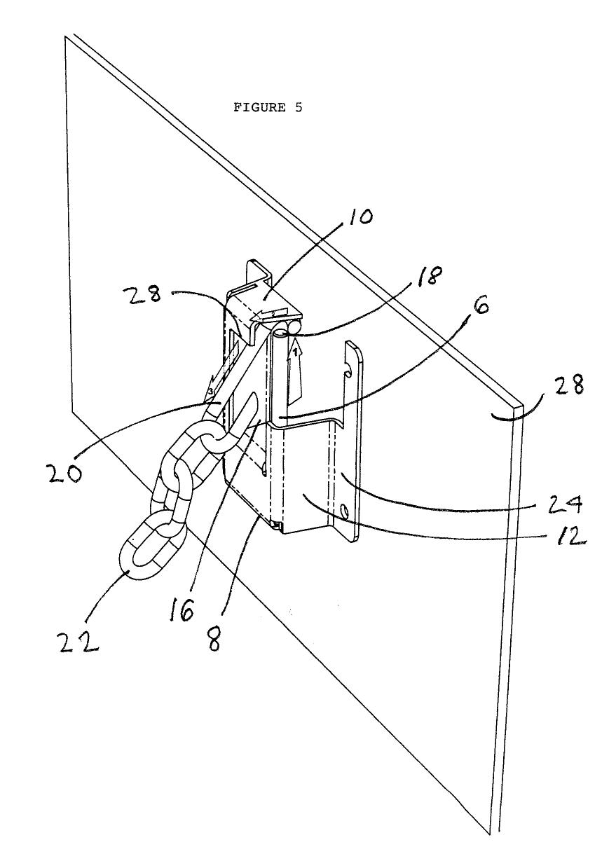

In FIGS. 4 and 5, the loop 20 is shown by the vertical arrow as having been moved upward along the post and by the diagonal arrow as being movable downward and outward in order to remove the chain from the bracket 2. In FIG. 5, the housing 4 has been partially cutaway to expose an interior.

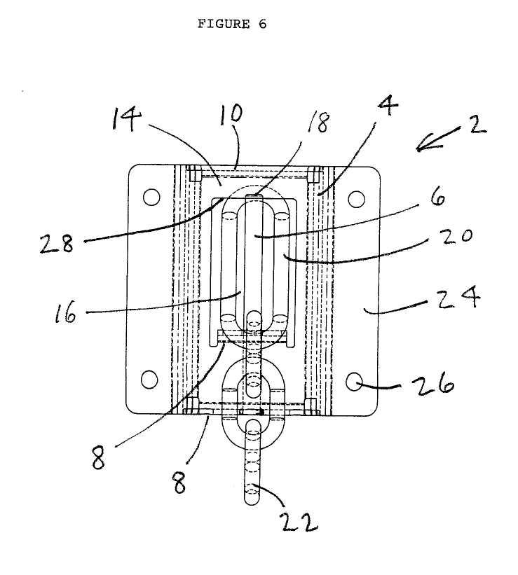

In FIG. 6, the loop is in a very similar position to that shown in FIG. 5. Since FIG. 6 is a front view, it can be readily seen that the free end 18 of the post 6 extends just above the lower edge 28 of the upper part of the frame 14 at the front of the housing 4.

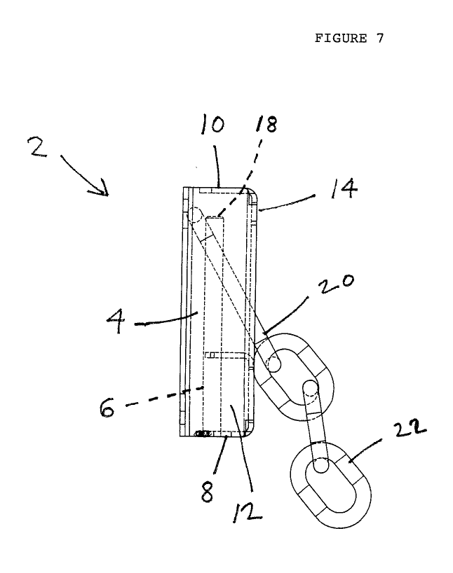

In FIG. 7, the loop 20 of the chain 22 is installed on the post 6, is at a point near the free end 18 of the post. When the loop 20 is released at that point, it will fall down by gravity and it will remain installed on the post until manually removed.

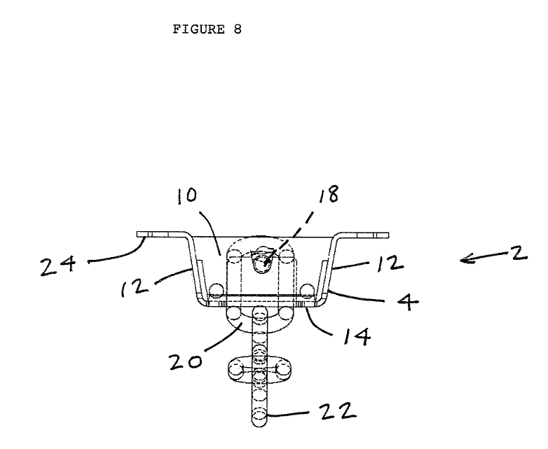

In FIG. 8, there is shown a top view of the bracket 2 and the chain 22. The top 10 extends substantially across the entire top of the bracket 2.

From FIGS. 1-8, it can be seen that when the bracket is mounted on a supporting surface, there is only one opening 16 through which the post can be accessed or contacted by the loop. There are no openings of sufficient size in the housing, other than the opening 16, through which the loop or into which the loop can be inserted. If the loop is inserted into the opening 16 without being installed over the post 6, the loop and chain will fall away from the bracket by gravity. There is therefore only one way to use the bracket in order to retain the chain and that is by installing the loop over the post.

While the supporting surface 28 is preferably an outer wall of a truck box, the latching bracket 2 can be mounted on any suitable supporting surface. For example, the supporting surface can be a fence where the latching bracket is used to hold a gate open or a wall at the stem of a boat where the latching bracket is used to attach a towing line for wake boarding, water skiing, tubing, or even towing another boat. When the latching bracket 2 is mounted on the supporting surface 28, the post 6 is completely encased in the housing 4 and there is no access for the loop 20 to the post 6 except through the opening 16.

The distance that the free end 18 is located above the lower edge 28 of the upper part of the frame can be varied for particular installations of the bracket. For example, if the bracket is being used on a boat where there is a lot of movement based on the water conditions and also the turning of the boat, the rope and loop are plastic and the movement of the water skier or other user, the latching bracket can be designed by having the free end extend higher into the housing above the lower edge 28 in order to ensure that the loop will not accidentally fall off the bracket.

For most circumstances for which the bracket is used, the distance of the free end above the lower edge of the upper part of the opening is sufficient. If the free end is moved further above the lower edge 28 than in shown in the drawings, the housing itself will be extended upward to enable the loop to be installed over the post. There must be sufficient distance between the top 10 and the free end 18 to allow the loop to be inserted. Usually, the loop is located at an end of the elongated flexible member. However, the loop can be located at any suitable location on the flexible member, or the flexible member can have a plurality of loops thereon to allow the flexible member to be connected to the bracket at different lengths. Numerous variations can be made within the scope of the attached claims.

We claim:

1. A latching bracket for use on an outside of a wall of a truck box to receive a loop on a flexibly elongated member, said bracket comprising a post mounted in a base and extending upward to a free end, said post being surrounded by a housing, said housing having an opening therein, said opening extending from said base to just beneath said free end, said opening being sized and shaped to allow a user to insert said loop through said opening and over said free end of said post, thereby removably affixing said elongated member to said bracket.

2. A latching bracket as claimed in claim 1 wherein said housing is said housing is said base and a frame, said opening being located in said frame.

3. A latching bracket as claimed in claim 2 wherein, when said bracket is properly installed on a truck body, said opening being the only opening through which a loop can be inserted.

4. A latching bracket as claimed in claim 2 wherein said free end is at least one thirty second ( 1/32) of an inch above said opening when said bracket is installed in an upright position and is viewed from a front.

5. A latching bracket for use on a supporting surface to receive a loop on a flexible elongated member, said bracket being mounted on said supporting surface, said bracket comprising a post mounted in a base and being surrounded by a frame, a top, two sides and said base, said frame having an opening therein, said post extending upward from said base to a free end that is separate and apart from said frame by a sufficient gap to enable said loop to be inserted into said frame and over said free end, said free end being behind part of said frame, a rear of said bracket being closed off by said supporting surface.

6. A latching bracket for use on an outside wall of a truck box to receive a loop located on a flexible elongated member, said bracket comprising a post extending upward from a base to a free end, said post being encased in a frame, two sides, a top and said base, said frame having an opening in a front thereof, said opening extending from said base to slightly beneath said free end, there being a cap between said free end and said frame, said opening being sized and shaped to allow a user to insert said loop through said opening and over said free end of said post, said bracket having attachment means for mounting said bracket on said wall.

7. A latching bracket as claimed in claim 5 wherein said loop is removable from said bracket by lifting the loop over the post and out of the opening.

8. A latching bracket and flexible elongated member in combination, said latching bracket being for use on a wall on a truck box and said flexible elongated member having a loop therein, said bracket comprising a post extending upward from a base, said post having a free end, said post being surrounded by a frame, said frame having an opening located therein, said opening extending from substantially said base to slightly beneath said free end, said opening being sized and shaped to allow a user to insert said loop through said opening and over said free end of said post, thereby removably affixing said elongated member to said bracket.

9. A latching bracket and flexible elongated member in combination as claimed in claim 7 wherein said loop is a ring.

10. A latching bracket and flexible elongated member in combination as claimed in claim 7 wherein said elongated member is a chain that is affixed to a hinged surface, said loop being a link of said chain that can be removably fixed to said bracket in order to hold said hinged surface in a desired position relative to said bracket.
